(19) United States
(12) Patent Application Publication
(10) Pub. No.: US 2025/0043468 A1
(43) Pub. Date: Feb. 6, 2025

(54) SYSTEMS AND METHODS FOR WOOL TEXTILE BASED ENERGY STORAGE

(71) Applicant: NUtech Ventures, Lincoln, NE (US)

(72) Inventors: Mona Bavarian, Lincoln, NE (US); Alyssa Grube, Lincoln, NE (US)

(21) Appl. No.: 18/790,224

(22) Filed: Jul. 31, 2024

Related U.S. Application Data
(60) Provisional application No. 63/516,728, filed on Jul. 31, 2023.

(51) Int. Cl. D02G 3/44; D02G 3/02; D02G 3/36; D04B 1/16; D04B 1/22; D06M 11/73; D06M 15/61; D06M 23/08; D06M 101/12; H01G 11/26; H01G 11/52; H01G 11/58

(52) U.S. Cl. CPC D02G 3/441; D02G 3/025; D02G 3/36; D04B 1/16; D04B 1/22; D06M 11/73; D06M 15/61; D06M 23/08; H01G 11/26; H01G 11/52; H01G 11/58; D06M 2101/12; D06M 2200/00; D10B 2211/01; D10B 2211/02; D10B 2401/16; D10B 2505/00

(57) ABSTRACT

Systems and methods are presented for fabricating conductive protein-based yarns to produce textile-based supercapacitors (TSCs). Conductive wool yarns are created by coating wool yarn with Ti₃C₂Tₓ MXene flakes, or by coating wool yarn in MXene@conductive-polymer composite material, such as MXene@polypyrrole (PPY) or MXene@polyaniline (PANI). In some examples, the conductive polymer (e.g., polypyrrole (PPY) or polyaniline (PANI)) is polymerized in the presence of MXene flakes to yield conductive-polymer-coated MXene flakes (MXene@conductive-polymer), and then this material is then used to coat wool yarn to yield a conductive protein-based yarn. MXene materials offer a high conductivity, but tend to oxidize quickly, while conductive polymers have a lower conductivity, but are more chemically stable and less likely to oxidize. As such, it is presently recognized that, by combining these materials, a chemically stable and highly conductive composite material is formed that can be used to coat yarns to make TSCs.

### CROSS-REFERENCE TO RELATED APPLICATIONS

This application claims priority to and the benefit of U.S. Provisional Application No. 63/516,728, filed Jul. 31, 2023, entitled “Wool Textile Based Energy Storage,” the disclosure of which is incorporated herein by reference in its entirety for all purposes.

### GOVERNMENT SUPPORT

This invention was made with government support under grant number 80NSSC20M0112 awarded by National Aeronautics and Space Administration. The government has certain rights in the invention.

### TECHNICAL FIELD

The present disclosure generally relates to systems and methods for manufacturing conductive protein-based yarns and for fabricating of wearable electronic devices using conductive protein-based yarns. More specifically, the present disclosure relates to systems and methods for fabricating conductive protein-based yarns that incorporate MXene materials, and for fabricating of textile-based supercapacitors (TSCs) using conductive protein-based yarns.

### BACKGROUND

Humans have been cultivating fibers from plants and animals and processing them into textiles to make clothes for thousands of years. With the advent of more affordable clothing and rapidly changing fashion trends, the demand for clothing has been steadily increasing. With the technological advances made over the last half a century, devices designed to generate, collect, and store energy are gaining momentum. In recent years, using clothing to harvest energy from body heat and movement has been viewed as the next logical step toward textile-based electronics. The combination of energy-storage devices with clothing creates power sources that are as mobile as the present generation of personal electronic devices. However, conventional energy storing devices, such as capacitors and batteries, are too rigid and bulky to be incorporated into clothing. Hence, there is a demand for soft and flexible energy storage devices.

Along these lines, several fabrication techniques have been developed to create textile-based electronics for powering personal electronics. One method involves printing circuits onto woven cloth using conductive ink. For this method, while printing locally stiffens the fabric, the clothing is still generally soft and flexible enough to wear comfortably, as demonstrated by the popularity of graphic T-shirts. A different fabrication method that preserves the flexibility of textiles is to create conductive threads from carbon-based materials and stitching circuits into cloth. An exciting innovation in the field of textile-based supercapacitors (TSCs) is to create conductive yarns by coating them with conductive materials and knitting circuits from these conductive yarns. This strategy increases the number of contact points the yarn has with itself, reducing the electrode resistance and losses. As such, TSCs offer superior performance in comparison with the printable electronics.

Among the various materials used to coat the fibers and render them conductive, MXene-based TSCs have gained significant attention from textile and material researchers. MXenes are conductive two-dimensional (2D) materials with a general chemical formula of Mn+1XnTx, where M is a transition metal carbide, X describes carbon and/or nitrogen, and T represents the surface terminations. While there are many different types of MXenes, Ti₃C₂Tₓ is the most extensively studied because it is more stable than other MXenes, has a conductivity up to 10,000 siemens per centimeter (S/cm), and excellent volumetric capacitance up to 1500 farads per cubic centimeter (F/cm³). Furthermore, Ti₃C₂Tₓ has demonstrated exceptional cation intercalation and pseudocapacitive behavior, excellent anti-microbial activities, non-toxicity when worn on the skin, and has high hydrophilic and mechanical properties that enable excellent solution and textile processability.

MXene flakes provide a unique coating for the production of conductive yarns, but there are challenges associated with the coating. The MXene flakes act like a pigment and stiffen the yarn during the coating process, and the yarn can break while knitting circuits if the yarn is stiffened too much by the MXene coating. Consequently, smaller MXene flakes are more appropriate to use when coating yarns for knitting textile-based electronics. Small flakes can penetrate through the yarn and coat individual fibers instead of forming a rigid shell around the yarn. Additionally, while MXene has satisfactory cycling stability, the material is susceptible to oxidation, and upon oxidative degradation of the MXene flakes, titanium dioxide (TiO₂) and carbon dioxide (CO₂) are produced.

Thus far, TSC research that explores coating yarn with conductive material has exclusively focused on using yarn spun from plant-based or artificial fibers, especially cotton and nylon. Even though these fibers are readily available, there are several drawbacks to the use of these fibers. Nylon is made from mined oil that has been chemically treated, and thus its manufacturing contributes to environmental pollution. Even if nylon is produced from recycled plastic, this does not address the plastic microfibers that are released every time nylon is washed, or the fact that the genesis of these materials was produced oil. While cotton is a naturally occurring fiber with good water uptake properties, due to the nature of its cultivation and processing, substantial amounts of polluted water are produced. As such, there remains a need to develop techniques using more environmentally friendly and sustainable fiber sources and to produce conductive yarns with enhanced oxidative stability.

### SUMMARY

Present embodiments relate to the production of conductive yarns from protein-based fibers, and in particular, sheep wool. Sheep wool was selected as a substrate for conductive materials because of its ready availability, sustainability, outstanding water uptake abilities, and insulating properties. As a keratin fiber, sheep wool has several unique properties that make it distinct from other fibers. Keratin fiber has more surface charges compared with cellulosic or synthetic fibers, giving wool its excellent water uptake properties. Because it is continuously grown by the sheep that can be sheared multiple times every year for the duration of their lives, sheep wool is more renewable than synthetic or cellulosic yarns, whereas other fibers require new crops to be planted or more oil to be consumed during production.

More specifically, present embodiments relate to the use of conductive protein-based yarns to produce textile-based supercapacitors (TSCs). In some embodiments, conductive yarn is created by coating wool yarn with Ti₃C₂Tₓ MXene flakes. In some embodiments, a conductive polymer (e.g., polypyrrole (PPY) or polyaniline (PANI)) is polymerized in the presence of MXene flakes to yield conductive-polymer-coated MXene flakes (MXene@conductive-polymer), and then this composite material is used to coat wool yarn to yield a conductive protein-based yarn. It is presently recognized that MXene materials offer a high conductivity, but tend to oxidize quickly, while conductive polymers have a lower conductivity, but are more chemically stable and less likely to oxidize. As such, it is presently recognized that, by combining these materials, a chemically stable and highly conductive composite material is formed that can be used to coat protein-based yarns to make TSCs. These conductive yarns were characterized, and the electrical performance of the conductive yarns and TSCs fabricated using these conductive yarns were evaluated. The results indicate that MXene-coated protein-based yarns and MXene@conductive-polymer-coated protein-based yarns are suitable for fabricating TSCs. Further, the results indicate that MXene@conductive-polymer-coated protein-based yarns, in particular, offer enhanced resistance to oxidation, which enables the fabrication TSCs with enhanced longevity compared to other MXene coated fibers.

Embodiments include a conductive protein-based yarn, including a plurality of keratin fibers coated with a composite material, the composite material including conductive-polymer-coated MXene flakes (MXene@conductive-polymer). In some embodiments, the MXene@conductive-polymer composite material includes polypyrrole (PPY)-coated MXene flakes (MXene@PPY). In some embodiments, the conductive protein-based yarn has a specific linear capacitance greater than 0.15 millifarad per centimeter (mF/cm). In some embodiments, the MXene@conductive-polymer composite material includes polyaniline (PANI)-coated MXene flakes (MXene@PANI). In some embodiments, the MXene flakes include Ti₃C₂Tₓ MXene flakes. In some embodiments, the conductive protein-based yarn includes from about 10 weight percent (wt. %) to about 25 wt. % of the MXene@conductive-polymer composite material. In some embodiments, the protein-based yarn is a sheep wool yarn, cashmere, or angora. In some embodiments, the plurality of keratin fibers has been coated with the composite material between five and ten times. In some embodiments, the plurality of keratin fibers coated with the composite material have a higher tensile stress at tensile strength and a higher load at tensile strength compared to the plurality of the keratin fibers prior to coating with the composite material.

Embodiments include a textile supercapacitor (TSC) having electrodes knitted from a conductive protein-based yarn, the conductive protein-based yarn being coated in a composite material, the composite material comprising conductive-polymer-coated MXene flakes (MXene@conductive-polymer). The TSC includes an electrode separator disposed between the electrodes and knitted from a non-conductive yarn, and an electrolyte absorbed into the conductive protein-based yarn of the electrodes and the non-conductive yarn of the electrode separator. In some embodiments, the MXene@conductive-polymer composite material includes polypyrrole (PPY)-coated MXene flakes (MXene@PPY). In some embodiments, the TSC has a specific areal capacitance greater than 180 millifarad per square centimeter (mF/cm²) at a scan rate of 5 millivolts per second (mV/s). In some embodiments, the MXene@conductive-polymer composite material includes polyaniline (PANI)-coated MXene flakes (MXene@PANI). In some embodiments, the TSC has a specific areal capacitance greater than 200 mF/cm² at a scan rate of 5 mV/s. In some embodiments, the conductive protein-based yarn includes from about 10 weight percent (wt. %) to about 25 wt. % of the MXene@conductive-polymer composite material. In some embodiments, the TSC includes hand-knitted stiches in an intarsia pattern. In some embodiments, the TSC includes machine-knitted jersey stiches. In some embodiments, the TSC is symmetric, and each of the electrodes is three stiches wide and four rows in height, and the electrode separator is two stiches wide and four rows in height.

Embodiments include a method that includes the step of combining MAX phase material with water, hydrochloric acid (HCl), and hydrofluoric acid (HF) at elevated temperature to yield MXene flakes. The method includes the step of polymerizing a monomer of conductive polymer in the presence of the MXene flakes to yield a composite material, the composite material including conductive-polymer-coated MXene flakes (MXene@conductive-polymer). The method includes the step of coating a protein-based yarn with the MXene@conductive-polymer composite material, thereby to yield a conductive protein-based yarn.

In some embodiments, the method includes the step of knitting a textile supercapacitor (TSC) using the conductive protein-based yarn, in which at least one electrode of the TSC is knitted from the conductive protein-based yarn. In some embodiments, the TSC is knitted using an intarsia knitting technique and includes one or more of garter stitches, purl stitches, stockinette stitches, or jersey stitches. In some embodiments, an electrode separator of the TSC is knitted from a polyethylene yarn and fashion region surrounding the TSC is knitted from a modal/nylon blend yarn. In some embodiments, the method includes the step of submerging the TSC in an electrolyte solution that contains phosphoric acid.

In some embodiments, coating the protein-based yarn with the MXene@conductive-polymer composite material further includes submerging the protein-based yarn in a colloidal solution of the MXene @conductive-polymer composite material and then drying the protein-based yarn, thereby to yield the conductive protein-based yarn. In some embodiments, coating the protein-based yarn with the MXene@conductive-polymer composite material further includes repeating the submerging and drying steps between four and nine times, thereby to yield the conductive protein-based yarn. In some embodiments, drying includes vacuum drying the protein-based yarn. In some embodiments, coating the protein-based yarn with the MXene@conductive-polymer composite material includes the steps of: loading a reservoir of an autocoater with the colloidal solution, loading a spool of the protein-based yarn into the autocoater, and activating the autocoater to automatically submerge the protein-based yarn in the colloidal solution and then to at least partially dry the protein-based yarn across a series of rollers.

In some embodiments, the protein-based yarn is a sheep wool yarn. In some embodiments, the protein-based yarn includes cashmere, angora, or silk. In some embodiments, the MAX phase material includes Ti₃AlC₂Tₓ MAX powder and the MXene flakes include Ti₃C₂Tₓ MXene flakes. In some embodiments, the conductive protein-based yarn lacks a Ti2p signal when measured by X-ray photoelectron spectroscopy (XPS). In some embodiments, the monomer is pyrrole and the MXene@conductive-polymer composite material includes polypyrrole (PPY)-coated MXene flakes (MXene@PPY). In some embodiments, the monomer is aniline and the MXene@conductive-polymer composite material includes polyaniline (PANI)-coated MXene flakes (MXene@PANI). In some embodiments, the conductive protein-based yarn includes from about 10 weight percent (wt. %) to about 25 wt. % of the MXene@conductive-polymer composite material.

Aspects and advantages of these exemplary embodiments and other embodiments, are discussed in detail herein. Moreover, it is to be understood that both the foregoing information and the following detailed description provide merely illustrative examples of various aspects and embodiments, and are intended to provide an overview or framework for understanding the nature and character of the claimed aspects and embodiments. Accordingly, these and other objects, along with advantages and features of the present disclosure, will become apparent through reference to the following description and the accompanying drawings. Furthermore, it is to be understood that the features of the various embodiments described herein are not mutually exclusive and may exist in various combinations and permutations.

### BRIEF DESCRIPTION OF THE DRAWINGS

The accompanying drawings, which are included to provide a further understanding of the embodiments of the present disclosure, are incorporated in and constitute a part of this specification, illustrate embodiments of the present disclosure, and together with the detailed description, serve to explain principles of the embodiments discussed herein. No attempt is made to show structural details of this disclosure in more detail than may be necessary for a fundamental understanding of the embodiments discussed herein and the various ways in which they may be practiced. According to common practice, the various features of the drawings discussed below are not necessarily drawn to scale. Dimensions of various features and elements in the drawings may be expanded or reduced to more clearly illustrate embodiments of the disclosure.

FIG. 1 is a diagrammatic representation of a method of preparing a conductive protein-based yarn using MXene flakes and fabricating TSCs from the conductive protein-based yarn, according to an embodiment.

FIG. 2 is a diagrammatic representation of a method of preparing a conductive protein-based yarn using conductive-polymer-coated MXene (MXene@conductive-polymer) and fabricating TSCs from the conductive protein-based yarn, according to an embodiment.

FIG. 3A is a diagrammatic representation of a symmetric TSC fabricated using a MXene-coated conductive wool yarn or a MXene@conductive-polymer-coated conductive wool yarn, according to an embodiment.

FIG. 3B is a photographic representation of an autoloader for use in the fabrication of the MXene-coated conductive wool yarns and the MXene@conductive-polymer-coated wool yarns, according to an embodiment.

FIGS. 4A-4D are scanning electron microscopy (SEM) images of pristine wool, MXene-coated wool, MXene@PPY-coated wool, and MXene@PANI-coated wool, according to an embodiment.

FIGS. 5A-5H are graphical representations of X-ray photoelectron spectroscopy (XPS) results for pristine wool, MXene-coated wool, MXene@PPY-coated wool, and MXene@PANI-coated wool, according to an embodiment.

FIGS. 6A and 6B are graphical representations of Fourier-transform infrared spectroscopy (FT-IR) spectra for the conductive polymers PANI and PPY relative to the MXene@PANI and MXene @PPY composite materials, according to an embodiment.

FIGS. 7A and 7B are respective graphical representations of capacitance-voltage (CV) and electrochemical impedance spectroscopy (EIS) curves for parallel yarn tests using conductive wool yarn coated five times with the MXene@PPY composite material, according to an embodiment.

FIGS. 7C and 7D are respective graphical representations of CV and EIS curves for parallel yarn tests using conductive wool yarn coated five times with the MXene@PANI composite material, according to an embodiment.

FIGS. 8A-8D illustrate the CV and EIS results of parallel yarn tests of conductive wool yarns that coated ten times with either the MXene@PPY composite material or the MXene@PANI composite material, according to an embodiment.

FIGS. 9A and 9B respectively illustrate CV and EIS curves for TSCs fabricated from conductive wool yarns coated five times with the MXene@PPY composite material, according to an embodiment.

FIGS. 9C and 9D respectively illustrate CV and EIS curves for TSCs fabricated from conductive wool yarns coated five times with the MXene@PANI composite material, according to an embodiment.

FIGS. 10A-10D illustrate the results of galvanostatic charge-discharge (GCD) curves and capacitance retention curves for MXene@PPY TSCs and MXene@PANI TSCs, according to an embodiment.

FIGS. 11A and 11B respectively illustrate CV and EIS curves for TSCs fabricated from conductive wool yarns coated five times with the MXene@PPY composite material while experiencing mechanical deformation, according to an embodiment.

### DETAILED DESCRIPTION

The present disclosure describes various embodiments related to systems and methods for the manufacture of conductive protein-based yarns (e.g., conductive sheep wool yarn), as well as the fabrication of TSCs using these conductive protein-based yarns. The description may use the phrases “in certain embodiments,” “in various embodiments,” “in an embodiment,” or “in embodiments,” which may each refer to one or more of the same or different embodiments. Furthermore, the terms “comprising,” “including,” “having,” and the like, as used with respect to embodiments of the present disclosure, are synonymous. The term “plurality” as used herein refers to two or more items or components. The terms “about” or “approximately” are defined as being close to as understood by one of ordinary skill in the art. In one non-limiting embodiment, these terms are defined to be within 10%, preferably within 5%, more preferably within 1%, and most preferably within 0.5%.

The use of the words “a” or “an” when used in conjunction with any of the terms “comprising,” “including,” “containing,” or “having,” in the claims or the specification may mean “one,” but it is also consistent with the meaning of “one or more,” “at least one,” and “one or more than one.” The terms “wt. %”, “vol. %”, or “mol. %” refers to a weight, volume, or molar percentage of a component, respectively, based on the total weight, the total volume of material, or total moles, which includes the component. In a non-limiting example, 10 grams of component in 100 grams of the material is 10 wt. % of component.

### Materials

Ti₃AlC₂Tₓ MAX powder (>90%, less than 40 micrometers (m)), 38% hydrofluoric acid (HF), and ortho-phosphoric acid crystals (99%, for the electrolyte) were purchased from Sigma Aldrich. Aniline monomer at 99.5% purity and pyrrole monomer at 98% purity were purchased from Sigma Aldrich. Hydrochloric acid (HCl, 37%) purchased from Fisher Chemical and lithium chloride (LiCl, 99%) purchased from Alfa Aesar were used during the MXene synthesis. 1-ply recycled polyester yarn was supplied by REPREVE and used for the electrode separator, lace-weight merino wool yarn in the color ecru was purchased from the Woolery, and the surrounding fashion yarn was purchased from Silk City Fibers in the color midnight and was an 85/15 modal/nylon blend. All example TSCs discussed herein were knit by hand using size zero Takumi bamboo double-pointed knitting needles (DPNs).

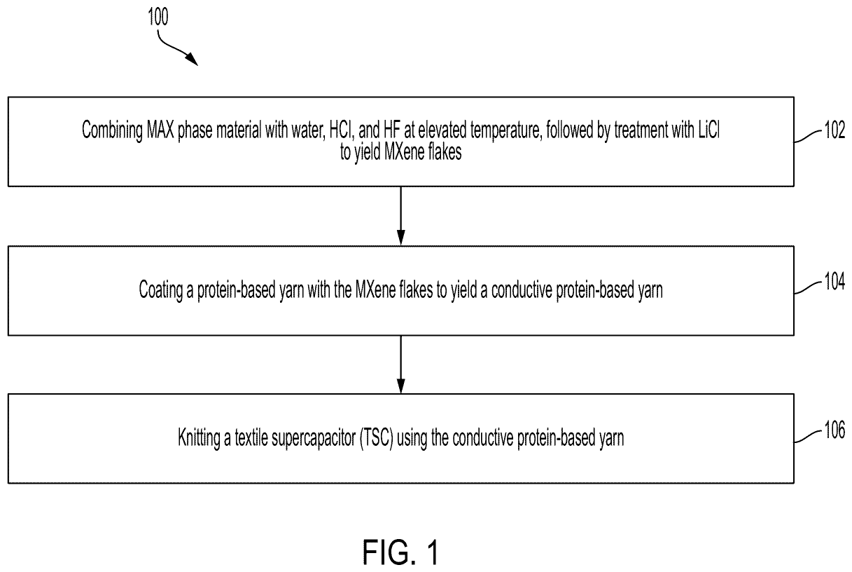

FIG. 1 is a diagrammatic representation of an embodiment of a method 100 of preparing a conductive protein-based yarn and fabricating TSCs from the conductive protein-based yarn. The method 100 begins with the step 102 of preparing the MXene flakes by combining a MAX phase material with water, HCl, and HF at elevated temperatures, followed by treatment with LiCl to yield MXene flakes. In an example embodiment, single-layer MXene flakes were produced by mixing 1 gram (g) of Ti₃AlC₂ MAX powder in a polypropylene bottle with 6 milliliters (mL) of deionized (DI) water, 12 mL HCl, and 2 mL HF. The bottle was then placed in a silicon oil bath, and the mixture was stirred for 24 hours at 35 degrees Celsius (° C.). The mixture was transferred to centrifugation tubes and centrifuged for 5 minutes (min) at 3000 revolutions per minute (rpm) to form centrifuge pellets. Residual acid was removed by pouring away the supernatant, refilling the centrifuge tubes with DI water, and resuspending the pellets before repeating the wash procedure until achieving pH of 6. Thereafter, 50 mL DI water and 1 g of LiCl were added to a vessel containing the intermediate MXene flakes before being suspended in the oil bath at 35° C. for 24 hours. A similar washing step followed, wherein the tubes were centrifuged for 20 min and the supernatant was checked for opacity, and opaque supernatant was then collected for further use.

For the embodiment illustrated in FIG. 1, the method 100 continues with the step 104 of coating a protein-based yarn with the MXene flakes to yield a conductive protein-based yarn. In an example embodiment, sheep wool hanks were dried overnight under continuous vacuum and weighed to determine their dry weight. The wool hanks were then submerged into a MXene colloidal solution having about 3.5 milligrams per milliliter (mg/mL) of MXene flakes and left to soak for one hour to allow the MXene flakes to bind to the surfaces of the wool fibers. The wool hanks were then suspended on a plastic stand and dried under continuously drawn vacuum to remove the DI water, before repeating the coating process three additional times to create MXene-coated wool yarns. In some embodiments, an autocoater may instead be used coat the protein-based yarn with the MXene flakes to produce the conductive protein-based yarn more quickly and/or at larger scale. It is presently recognized that, unlike cellulose fibers such as cotton, the coating of protein-based yarns with the MXene flakes or the MXene@conductive-polymer composite materials (discussed below) does not involve an initial treatment in which the raw yarn is scoured before coating. That is, cellulose fibers must first be treated, for example, by being placed in a solution of a base (e.g., sodium bicarbonate) at elevated temperature to introduce surface charges to the fibers before coating can occur. However, because protein-based fibers, such as wool fibers, already possess surface charges at the surface of fibers, it is presently recognized that this step can be desirably omitted. Further, it is presently recognized that attempting to treat wool fibers in this manner undesirably results in breakdown of the wool fibers into felt, rendering them unsuitable for use in constructing TSCs.

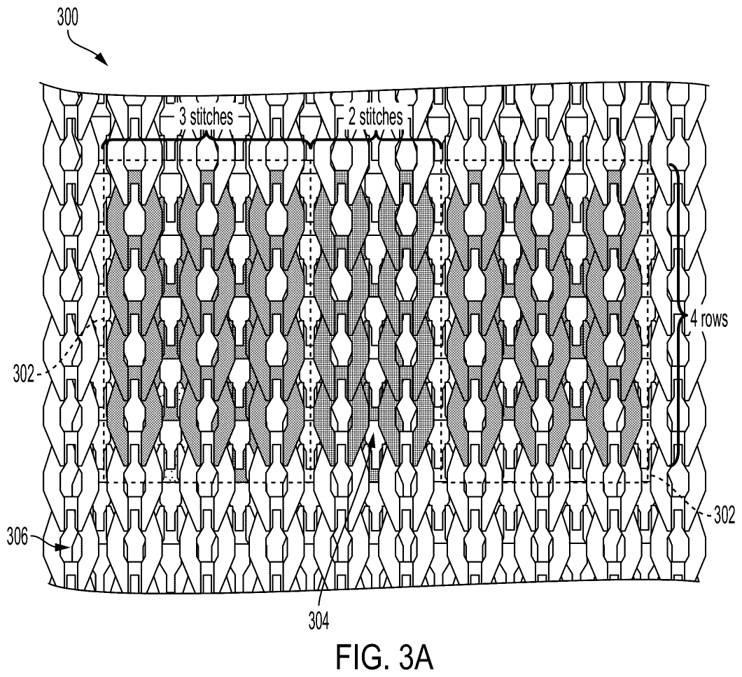

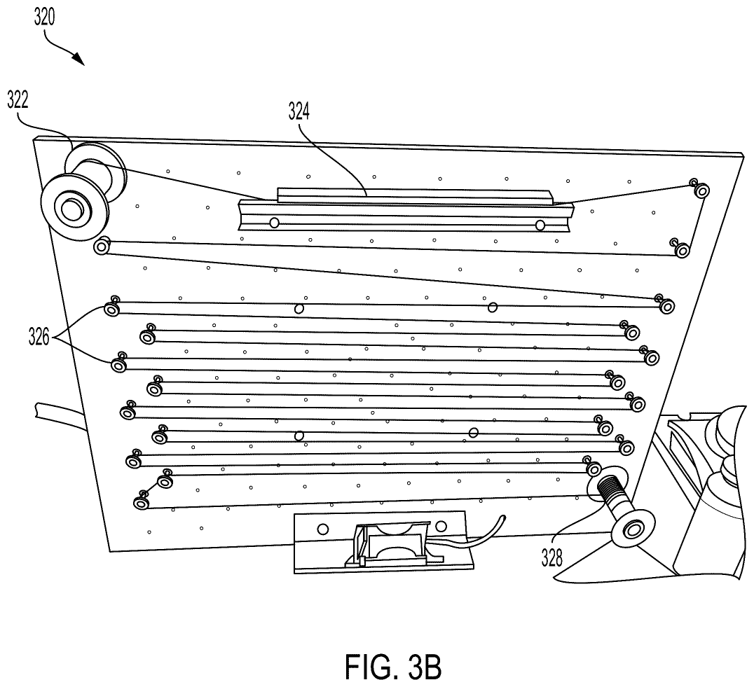

For the embodiment illustrated in FIG. 1, the method 100 continues with the step 106 of knitting a TSC using the conductive protein-based yarn. In an example embodiment, TSCs were knit by hand using the intarsia knitting technique, such that each electrode was three stitches wide and four stitches tall, separated by two stitches. MXene-coated wool yarn was used for the TSC electrodes, recycled polyethylene yarn was utilized as the electrode separator, and a modal/nylon blend was employed as the fashion yarn surrounding the circuit. For the example embodiment, TSCs were knit in alternating rows of garter stitch on odd rows and purl stitch on even rows to create a stockinette stitch to approximate a jersey stitch used on machine-knit fabric. An example TSC device is illustrated in FIG. 3A, as discussed below. In other embodiments, TSCs may be machine-knit using, for example, a jersey stitch. It may be appreciated that the Stockinette stitch is the hand knitting equivalent/term for jersey knit, including of one row of garter/knit stitches, and then one row of purl stitches.

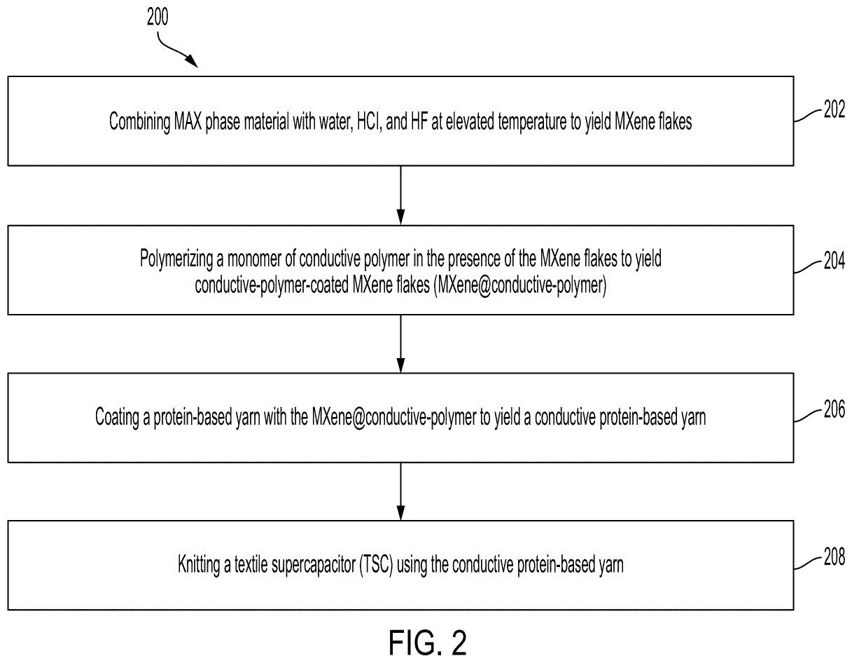

FIG. 2 is a diagrammatic representation of an embodiment of a method 200 of preparing a conductive protein-based yarn using conductive-polymer-coated MXene and fabricating TSCs from the conductive protein-based yarn. The method 200 begins with the step 202 of preparing the MXene flakes by combining a MAX phase material with water, HCl, and HF at elevated temperature to yield MXene flakes. In an example embodiment, single-layer MXene flakes were produced by mixing 1 g of Ti₃AlC₂ MAX powder in a polypropylene bottle with 6 mL of DI water, 12 mL HCl, and 2 mL HF. The bottle was then placed in a silicon oil bath, and the mixture was stirred for 24 hours at 35° C. The mixture was transferred to centrifugation tubes and centrifuged for 5 min at 3500 rpm to form centrifuge pellets. Residual acid was removed by pouring away the supernatant, refilling the centrifuge tubes with DI water, and resuspending the pellets before repeating the wash procedure until achieving pH of 6. The concentration of MXene flakes was determined by filtering a known quantity of solution through a Celgard membrane of a known weight, drying the film, and then weighing the membrane and film to determine the concentration. It is noted that the LiCl treatment of step 102 of the method 100 is not performed as part of the method 200, which desirably reduces manufacturing time and simplifies the fabrication process.

For the embodiment illustrated in FIG. 2, the method 200 continues with the step 204 of polymerizing a conductive polymer in the presence of the MXene flakes to yield conductive-polymer-coated MXene flakes, which are also referred to herein as MXene@conductive-polymer. Various conductive polymers may be used in different embodiments. In one example embodiment, pyrrole monomer was added to the MXene flakes produced in step 202 in a 1:1 weight ratio and stirred at room temperature or 12 hours to yield polypyrole (PPY)-coated MXene flakes, which are also referred to herein as MXene@PPY. In another example embodiment, aniline monomer was added to the MXene flakes produced in step 202 in a 1:1 weight ratio and stirred at room temperature or 12 hours to yield polyaniline (PANI)-coated MXene flakes, which are also referred to herein as MXene@PANI. After polymerization, the MXene@PPY or MXene@PANI composite materials were cooled to a temperature from about 10° C. to about 15° C. and sonicated under argon bubbling before centrifuging and collecting the supernatant. It may be appreciated that, unlike other polymerization techniques, the polymerization used to form MXene@conductive-polymer lacks a separate oxidant reagent, as the surface terminations of the MXene flakes themselves act as proton donors/acceptors to polymerize the conductive polymers.

For the embodiment illustrated in FIG. 2, the method 200 continues with the step 206 of coating a protein-based yarn with the MXene@conductive-polymer composite material to yield a conductive protein-based yarn. In general, the coating process involves repeatedly (e.g., five to ten times) submerging the protein-based yarn into a colloidal solution of the MXene@conductive-polymer composite material and then drying (e.g., vacuum drying) the coated protein-based yarn. For example, in some embodiments, the protein-based yarn is submerged in the colloidal solution of the MXene@conductive-polymer composite material and dried, and the coating process repeated between four and nine additional times to yield the conductive protein-based yarn. In some embodiments, the colloidal solution contains about 7 g/mL of the MXene@conductive-polymer composite material. In some embodiments, an autocoater may instead be used to repeatedly coat the protein-based yarn with the MXene@conductive-polymer composite material and to repeatedly dry the coated protein-based yarn to produce the conductive protein-based yarn more quickly and/or at larger scale.

For the embodiment illustrated in FIG. 2, the method 200 continues with the step 208 of knitting a TSC using the conductive protein-based yarn. In an example embodiment, TSCs were knit by hand using the intarsia knitting technique. These TSCs were fabricated with symmetric or asymmetric geometry. For the example embodiment, TSCs were knit using a two-rib stitch and had an electrode separation of two stitches. Symmetric TSCs were knitted such that both electrodes were four rows tall and three stitches wide, and asymmetric TSCs had one electrode that was four rows tall and two stitches wide with the other electrode being four rows tall and four stitches wide. The MXene@conductive-polymer-coated wool yarn was used for the TSC electrodes, recycled polyethylene yarn was utilized as the electrode separator, and a modal/nylon blend was employed as the fashion yarn surrounding the circuit. An example TSC device is illustrated in FIG. 3A, as discussed below. In other embodiments, TSCs may be machine-knit using, for example, a jersey stitch.

FIG. 3A is a diagrammatic representation of an embodiment of a symmetric TSC 300 fabricated using a MXene-coated conductive wool yarn (as produced in step 104 of the method 100 of FIG. 1) or a MXene@conductive-polymer-coated conductive wool yarn (as produced in step 206 of the method 200 of FIG. 2). It may be noted that, in other embodiments, asymmetric TSCs may alternatively be fabricated. The illustrated symmetric TSC 300 includes two electrodes 302 knit from conductive wool yarn, and each of the electrodes 302 is three stiches wide and four rows tall. The illustrated symmetric TSC 300 includes a two-stitch separator 304 knit from a recycled polyethylene yarn that separates the electrodes 302 from one another. The illustrated symmetric TSC 300 includes a fashion region 306 that was knitted using a modal/nylon blend yarn to surround and isolate the circuit. It should be appreciated that the dimensions, the stitching, and the selection of conductive and non-conductive yarns are merely provided as an example and may be different in other embodiments. It may also be appreciated that, while the present disclosure focuses on the use of wool yarns, it is believed that the techniques disclosed herein are applicable to other types of protein-based yarns, including but not limited to cashmere, angora, and silk. It may further be appreciated that, while the present disclosure focuses on the use of Ti₃C₂Tₓ MXene materials, in other embodiments, other MXene materials may additionally or alternatively be used, including but not limited to vanadium-based MXene materials (e.g., V₄C₃Tₓ).

FIG. 3B is a photographic representation of an embodiment of an autocoater 320 that may be used in the fabrication of the MXene-coated conductive wool yarns, as well as the MXene@PPY and MXene@PANI conductive wool yarns. During operation, a spool or bobbin 322 of yarn to be coated is loaded into the autocoater. The yarn is then fed through a reservoir 324 that contains a colloidal solution of the MXene flakes or the MXene@conductive-polymer composite material, and the yarn is submerged in the colloidal solution to be coated by the MXene flakes or the MXene@conductive-polymer composite material of the colloidal solution. The coated yarn then traverses a series of rollers 326 that remove excess colloidal solution from the yarn and promote drying of the yarn. The coated yarn is then collected on the spool or bobbin 328 and may be subsequently dried under vacuum. In some embodiments, the yarn may be fed through the autoloader multiple times (e.g., five to ten times) to yield the conductive yarn. In some embodiments, the autocoater 320 may include a number of loading stages, as opposed to the single loading stage illustrated in FIG. 3B, and the multi-stage autocoater may perform multiple coatings of the yarn in a single pass to yield the conductive yarn.

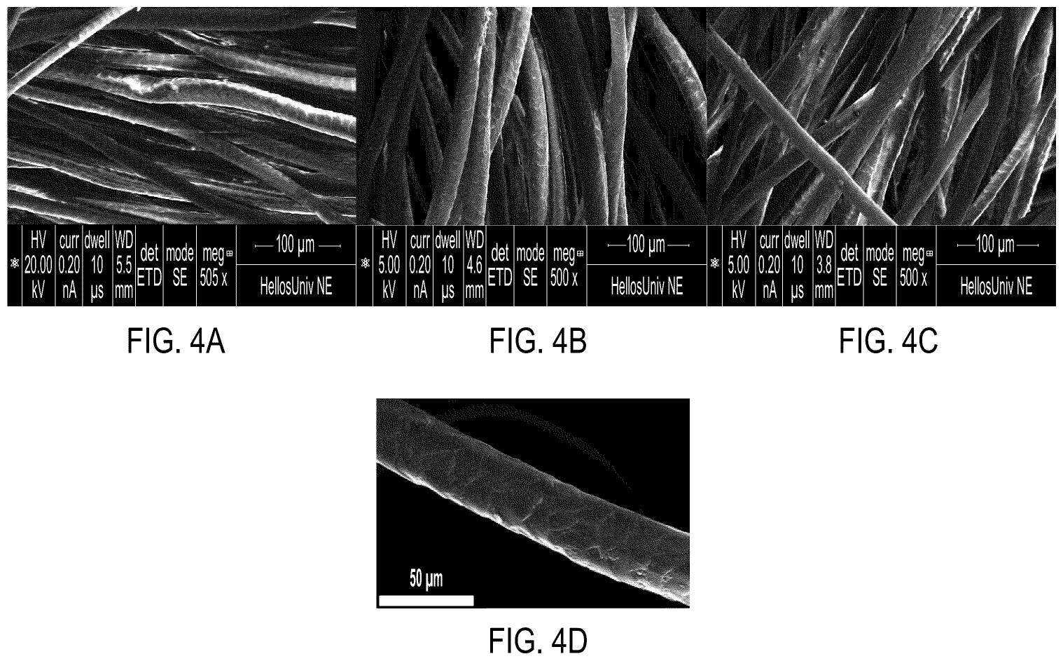

FIGS. 4A-4D illustrate scanning electron microscopy (SEM) images of different wool yarn fibers. SEM images were collected using a Nova NanoSEM450 from Thermo Fisher Scientific. FIG. 4A illustrates uncoated wool yarn fibers, FIG. 4B illustrates a MXene@PPY conductive wool fibers after five coating steps, FIG. 4C illustrates a MXene@PANI conductive wool fibers after five coating steps, and FIG. 4D illustrates MXene-coated conductive wool fibers. For the uncoated wool illustrated in FIG. 4A, the rough cuticle surface of the wool fibers is observed. For wool fibers coated five times with the MXene@PPY composite material, as illustrated in FIG. 4B, clusters of the composite flakes are observed adhered to the surface of individual fibers. For wool yarn fibers coated five times with the MXene@PANI composite material, as illustrated in FIG. 4C, flakes of the composite material are observed on the wool fiber surface. Similarly, for the MXene-coated conductive wool fibers illustrated in FIG. 4D, MXene flakes were observed on the wool fiber surface. In some embodiments, the MXene-coated yarns have a loading of MXene flakes up to about 40 wt. %, based on the weight of the conductive yarn. In some embodiments, the MXene@conductive-polymer-coated yarns have a loading of MXene@conductive-polymer composite material ranging from about 10 wt. % to about 25 wt. % (e.g., about 23 wt. % or less), based on the weight of the conductive yarn.

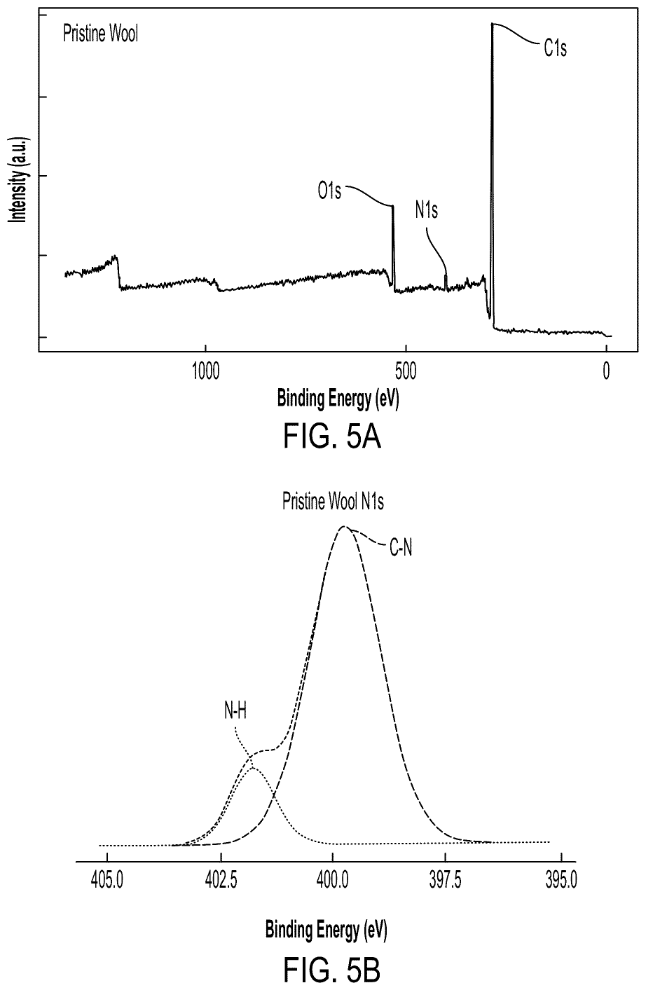

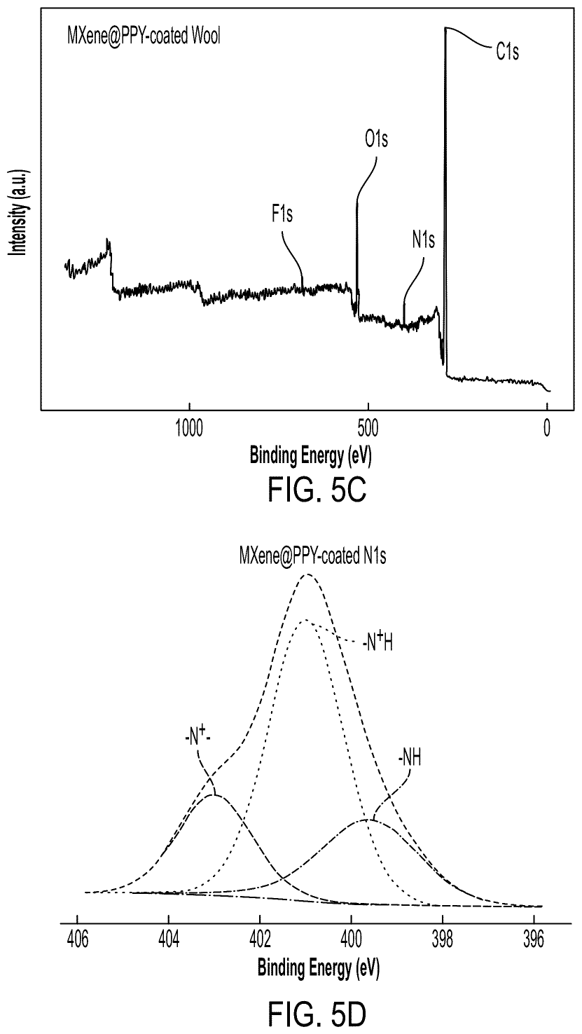

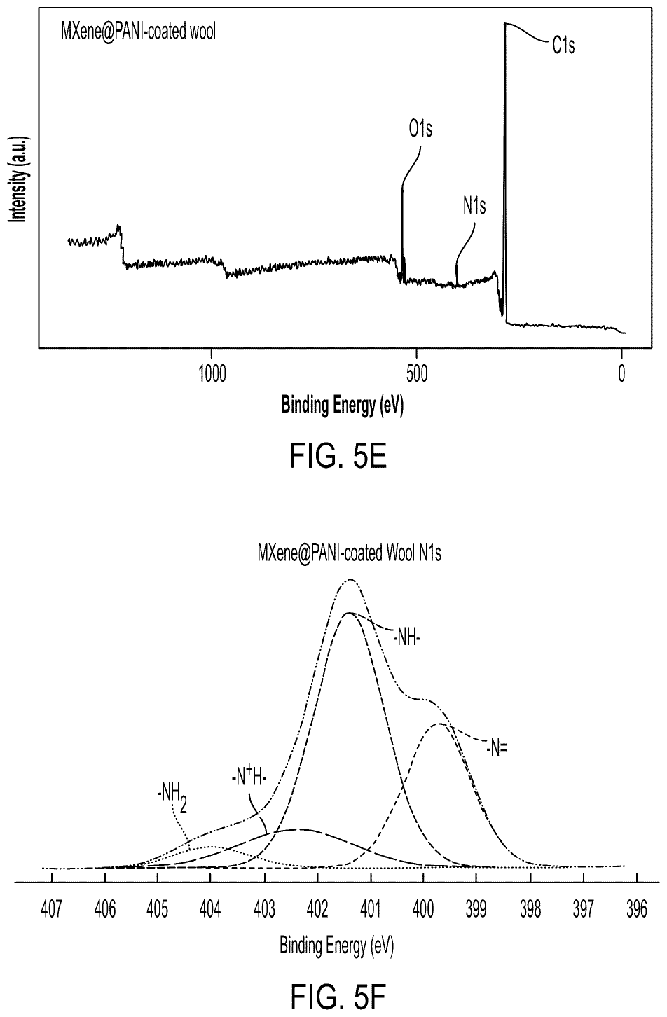

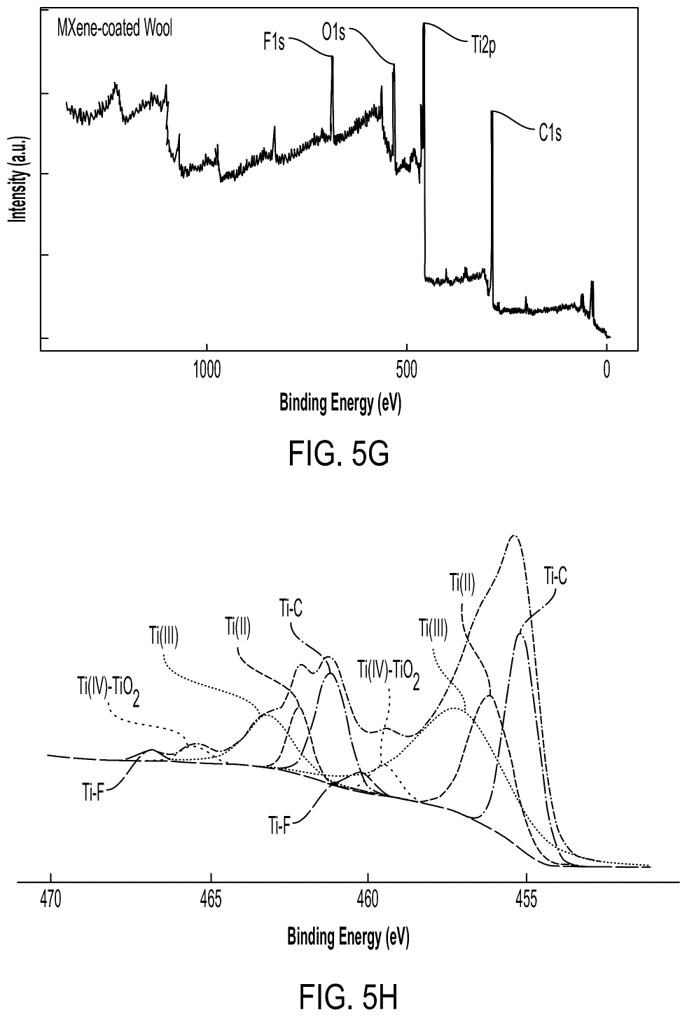

FIGS. 5A-G illustrate X-ray photoelectron spectroscopy (XPS) results for pristine wool, MXene-coated wool, MXene@PPY-coated wool, and MXene@PANI-coated wool. A K-alpha XPS system from Thermo Scientific was used for collecting XPS spectra, and Avantage software was used to run the experiments and analyze the measured data. Nitrogen, sulfur, titanium, oxygen, carbon, and fluoride were scanned during XPS testing. FIG. 5A illustrates the XPS results for pristine wool, and FIG. 5B illustrates the deconvoluted Nis peaks from the XPS results for pristine wool. FIG. 5C illustrates the XPS results for MXene@PPY-coated wool, and FIG. 5D illustrates the deconvoluted N1s peaks from the XPS results for the MXene@PPY-coated wool. FIG. 5E illustrates the XPS results for MXene@PANI-coated wool, and FIG. 5D illustrates the deconvoluted N1s peaks from the XPS results for the MXene@PANI-coated wool. FIG. 5G illustrates the XPS results for MXene-coated wool, and FIG. 5H illustrates the deconvoluted Ti2p peaks from the XPS results for MXene-coated wool.

As illustrated in FIG. 5G, C1s, Ti2p, O1s, and F1s peaks are observed due to the MXene coating on wool, while in the XPS spectra illustrated in FIGS. 5C and 5E for wool coated in a MXene-conductive-polymer composite materials feature no Ti2p peaks. This indicates successful coating of the MXene flakes with the conductive polymers. The deconvoluted N1s peak for MXene@PANI-coated wool illustrated in FIG. 5F indicates a peak at 399.74 electron volts (eV) attributed to the —N=bonds in the PANI coating, the peak at 401.4 eV is attributed to the —NH-bonds, the peak at 402.4 eV is attributed to —N+H— bonds, and the peak at 404 eV is attributed to —NH₂ bonds. The deconvoluted N1s peak for MXene@PPY-coated wool illustrated in FIG. 5F indicates a peak at 399.6 eV attributed to the —NH bonds present in PPY, a peak at 401 eV attributed to —N+H bonds, and a peak at 403 eV attributed to —N+— bonds.

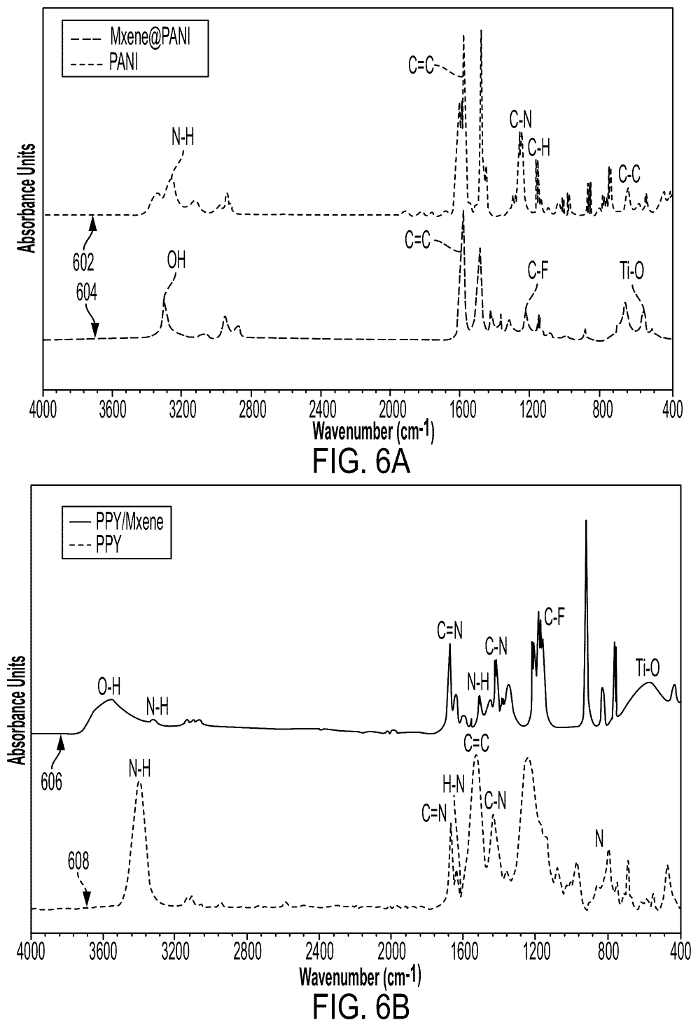

FIGS. 6A and 6B illustrate Fourier-transform infrared spectroscopy (FT-IR) spectra for the conductive polymers PANI and PPY relative to the MXene@PANI and MXene@PPY composite materials. More specifically, the top plot 602 of FIG. 6A illustrates the FT-IR spectrum for PANI alone, while the bottom plot 604 illustrates the FT-IR spectrum for the MXene@PANI composite material. The top plot 606 of FIG. 6B illustrates the FT-IR spectrum for PPY alone, while the bottom plot 608 illustrates the FT-IR spectrum for the MXene @PPY composite material.

With respect to FIG. 6A, the FTIR spectra clearly indicate characteristic peaks at 1496 inverse centimeters (cm⁻¹) and 1599 cm⁻¹ corresponding to the C═C stretching vibrations of benzenoid and quinonoid rings. The band around 3351 cm⁻¹ corresponds to the N—H stretching vibration. Moreover, C—N stretching of secondary aromatic amine is observed near 1310 cm⁻¹, and C—H in-plane and C—H out-of-plane bending vibrations are also found at 1174 cm⁻¹ and 747.46 cm⁻¹, respectively. The band at 689 cm⁻¹ is due to the C—C bonding of aromatic ring. The absorption peaks of MXene at 3299 cm⁻¹ corresponds to the stretching vibration of —OH functional groups on the surface of MXene. The stretching vibration of (C—F) on the surface of MXene appears at 1230 cm⁻¹. At the same time, the characteristic absorption peak of MXene Ti—O at 567 cm⁻¹ is still present. The above results indicate the synthesis and presence of PANI on the MXene surface.

With respect to FIG. 6B, the FT-IR spectrum of 2D porous MXene@PPY displays the characteristic peaks of polypyrrole at 3310.24 cm⁻¹ and 1594 cm⁻¹, which can be attributed to the N—H stretching vibration and N—H deformation. Also, the absorption peaks of polypyrrole at 1651 cm⁻¹, 1343 cm⁻¹ and 1423 cm⁻¹ correspond to C═N stretching, C—N deformation, and C—N stretching vibration. Additionally, the absorption peak of MXene at 3545.7 cm⁻¹ corresponds to the stretching vibration of —OH functional groups on the surface of MXene. The stretching vibrations of C—F and Ti—O on the surface of MXene appear at 1178.21 cm⁻¹ and 622.61 cm⁻¹. Moreover, the characteristic peaks of PPY/Ti₃C₂ at 1215.8 cm⁻¹ and 923.61 cm⁻¹ are associated with the stretching vibrations of the doped PPY, indicating polymerization of the pyrrole on the surface of MXene.

As shown in the plot 608 of FIG. 6B, pure PPY has a N—H stretching vibration peak of 3393 cm⁻¹, N=H in plane bending vibration peak of 1631 cm⁻¹, C=N stretching vibration peak of 1672 cm⁻¹ and 3393 cm⁻¹, C—N stretching vibration peak of 1431 cm⁻¹, C—N in plane bending vibration peak of 1358 cm⁻¹, and the C═C stretching vibration in the pyrrole ring at 1524 cm⁻¹. It is noted that the C—N stretching vibration peak of pure PPY is located at 1431 cm⁻¹, while it shifts to a smaller wavenumber in MXene@PPY composite material. Also, the characteristic peak of N—H wagging shifted from 791.8 cm⁻¹ to 764.5 cm⁻¹ and became stronger, indicating the strong electrostatic interaction between PPY and Ti₃C₂Tₓ MXene flakes. These results indicate that pyrrole can be polymerized in contact with MXene.

Measurements were performed on pristine wool yarn, MXene-coated wool yarn, MXene@PPY-coated wool yarn, and MXene@PANI-coated wool yarn to determine differences in material properties as a result of the coating process. Table 1 and Table 2 indicate the results of tensile testing of these wool yarns. In Table 1, maximum load is indicated in Newtons (N), extension at maximum load is indicated in millimeters (mm), load at break is indicated in Newtons (N), extension at break is indicated in millimeters (mm), and percent elongation is indicated as a percentage (%), for pristine wool and MXene-coated wool yarns. In Table 2, tensile stress at tensile strength is indicated in Newtons (N), tensile strain at break is indicated as a percentage (%), Young's modulus is indicated in gigapascal (GPa), and load at tensile strength is indicated in millinewtons (mN), for pristine wool, MXene-coated wool yarns, and MXene@conductive-polymer wool yarns. The low percent elongation of the pristine wool yarn is attributed to the lace weight of the yarn used as the substrate for the composite material. Coating with MXene flakes increased the elongation the wool yarn extends prior to breaking to about 2.5 times that of the pristine wool yarn. Additionally, the wool yarns coated with MXene flakes and the MXene@conductive-polymer composite materials demonstrated increased load and tensile stress at failure. The MXene-coated wool demonstrated increased elasticity, as evidenced by the decreased value for the Young's modulus. Wool yarns coated with the MXene@conductive-polymer composites demonstrated increased rigidity, as evidenced by the increased values for the Young's modulus. All conductive coatings decreased the tensile strain at failure. Additionally, MXene@PPY-coated wool prepared with ten coating steps demonstrated higher rigidity, as indicated by an increased value of the Young's modulus, tensile stress, and load at failure.

TABLE 1
Tensile testing results of pristine wool yarn, MXene-
coated wool yarn, wool yarn coated with the two different
MXene@conductive-polymer composite materials.

| | | Extension | | | |
|---|---|---|---|---|---|
| | Maximum | at Maximum | Load | Extension | Percent |
| | Load | Load | at Break | at Break | Elongation |
| Sample | (N) | (mm) | (N) | (mm) | (%) |
| Pristine | 10.64 | 35.56 | 10.11 | 36.8 | 9.62 |
| Wool | | | | | |
| MXene- | 11.99 | 90.93 | 11.9 | 91.59 | 23.9 |
| coated Wool | | | | | |

TABLE 2
Tensile testing results of pristine wool yarn, MXene-
coated wool yarn, wool yarn coated with the two different
MXene@conductive-polymer composite materials.

| | Tensile | | | |
|---|---|---|---|---|
| | stress at | | | Load at |
| | tensile | Tensile strain | Young's | tensile |
| | strength | at break | modulus | strength |
| Sample | (MPa) | (%) | (GPa) | (mN) |
| Pristine | 197.31 | 39.13 | 4.48 | 83.12 |
| Wool | | | | |
| MXene-coated | 204.93 | 36.11 | 4.11 | 86.33 |
| Wool | | | | |
| MXene@PPY | 205.84 | 36.92 | 4.84 | 86.72 |
| Wool | | | | |
| MXene@PANI | 212.5 | 34.5 | 4.56 | 89.5 |
| Wool | | | | |

### Electrical Testing

For parallel yarn testing, wool yarns coated with MXene@PPY or MXene@PANI were attached to gold pins at a 4 millimeter (mm) separation distance and submerged in 1 molar (M) phosphoric acid electrolyte for 10 minutes prior to testing. All TSCs were soaked in 1 M phosphoric acid electrolyte for 10 minutes prior to testing. It may be appreciated that phosphoric acid is merely provided as an example electrolyte, and in other embodiment, other suitable electrolytes may be used, including an aqueous sodium chloride solution or perspiration. In some embodiments, polyvinyl alcohol (PVA)-based electrolytes may be avoided, as it is presently recognized that these can undesirably solidify after soaking, resulting in slower charging and discharging of the TSCs. In some embodiments, sulfuric acid (H₂SO₄)-based electrolytes may be avoided, as it is presently recognized that these electrolytes can undesirably degrade conductive yarns over time.

All electrochemical tests of parallel yarns and symmetric TSCs were performed using a Gamry 1000E Potentiostat in a two-electrode setup using gold pins as current collectors. CV curves were collected over a potential window of −0.5 volts (V) to 0.5 V at scan rates of 50, 20, 10, and 5 millivolts per second (mV/s). EIS tests were performed over frequencies from 100 kilohertz (kHz) to 0.1 hertz (Hz) with a direct current (DC) offset voltage of 10 V. Gamry Echem Analysis was used to export data to a spreadsheet and create equivalent circuit models (ECMs). R was used to plot the measured data and generate Tafel and BV plots. For at least some electrical testing of the TSCs, the devices were stretched lengthwise along their wale or widthwise across their course and secured in place. Electrolyte was added, stainless steel flat tip alligator clips were attached to the electrodes as current collectors, and the same electrochemical tests were run to predict how wearing a garment with the TSC incorporated into it would affect its charge storage and resistive behavior.

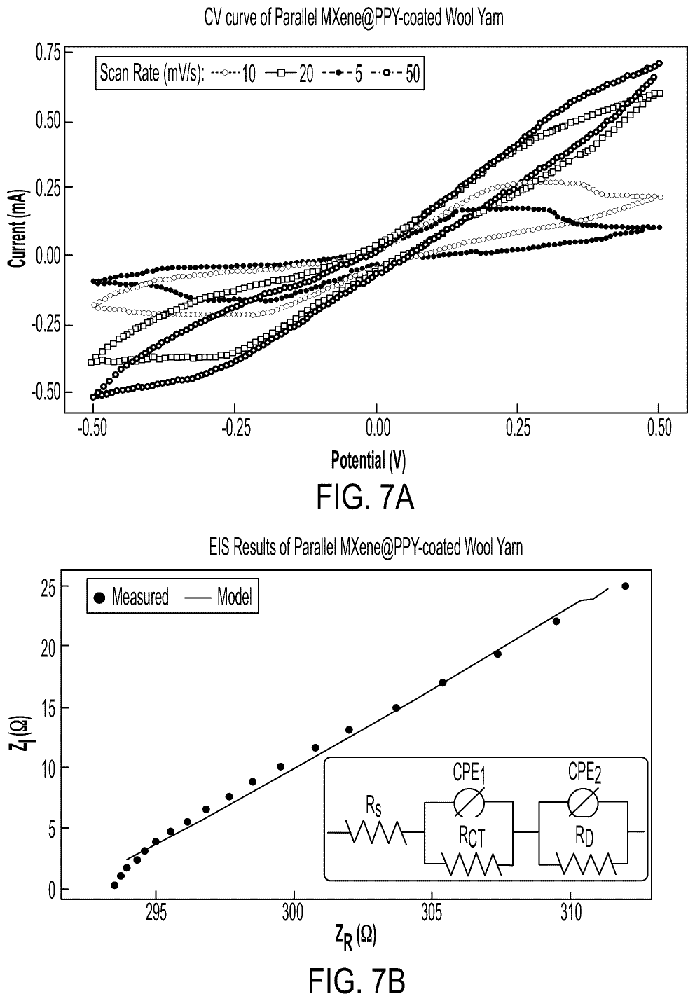

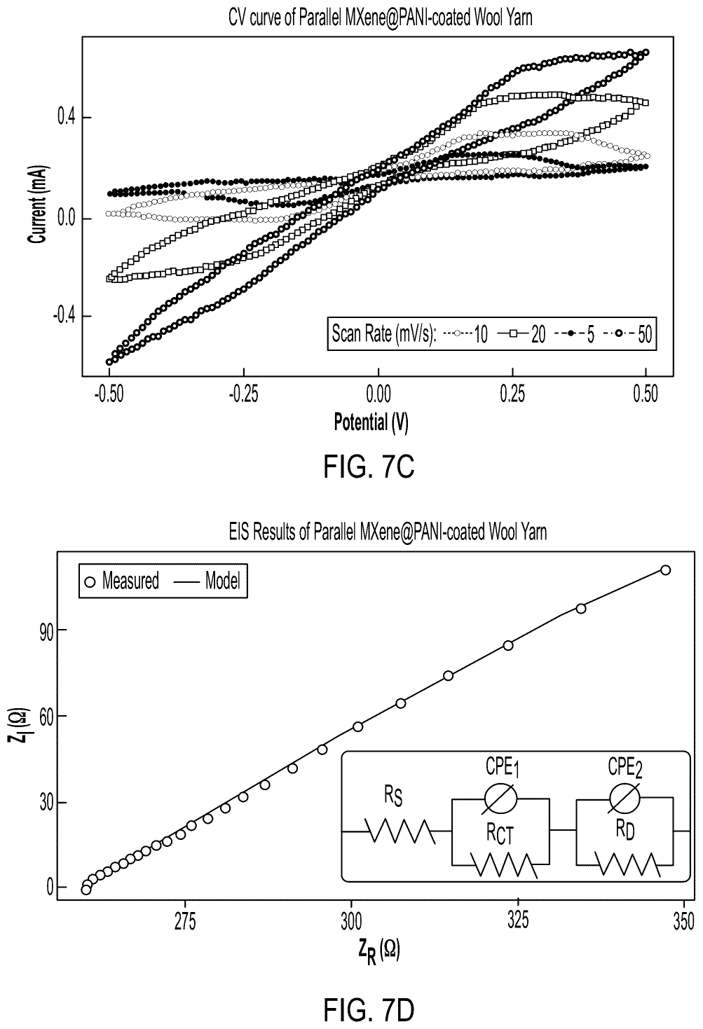

FIGS. 7A and 7B respectively illustrate capacitance-voltage (CV) and electrochemical impedance spectroscopy (EIS) curves for parallel yarn tests using conductive wool yarn coated five times with MXene@PPY. Redox peaks on the anodic and cathodic portions of the CV curve of FIG. 7A were observable at all scan rates, and the specific linear capacitance was 0.18 millifarad per centimeter (mF/cm) (e.g., greater than 0.15 mF/cm). In the EIS curve of FIG. 7B, the semicircular portion is flattened, indicating a rough 3-dimensional (3D), non-ideal surface. The equivalent circuit model (ECM) inset in FIG. 7B features a series resistor (RS) representing the resistance contributed by the contact with the current collector and the electrode spacing. A constant phase element (CPE) disposed in parallel with a resistor (RCT) represents the capacitance and resistance contributed by the Stem layer at the electrode surface, where ion exchange occurs during the redox reactions. The CPE is analogous to a capacitor, but used to represent the capacitance of rough 3D surfaces with a measurement of ideality ranging from 0 to 1 (with 1 being ideal and 0 being non-ideal). A second CPE represents the capacitance contributed by the Helmholtz layer, followed by another CPE in parallel with a resistor (RD) to represent the capacitance and resistance from the diffuse layer in between the electrodes.

FIGS. 7C and 7D respectively illustrate CV and EIS curves for parallel yarn tests using conductive wool yarn coated five times with MXene@PANI. Redox peaks on the anodic portion of the CV curve of FIG. 7C were observable at all scan rates, and the specific linear capacitance was greater than 0.15 mF/cm. In the EIS curve of FIG. 7D, there is a more pronounced semicircle at lower frequencies, indicating a smoother surface. The ECM inset in FIG. 7D features a series resistor (R_{S}) representing the resistance contributed by the contact with the current collector and the electrode spacing. A CPE in parallel with a resistor (R_{CT}) represent the capacitance and resistance contributed by the Stern layer at the electrode surface, where ion exchange occurs during the redox reactions. A second CPE represents the capacitance contributed by the Helmholtz layer, followed by another CPE in parallel with a resistor (R_{D}) to represent the capacitance and resistance contributed by the diffuse layer in between the electrodes.

Based on the parallel yarn testing, MXene@PPY-coated wool yarns demonstrated a higher series resistance (R_{S}) than the MXene@PANI-coated wool yarns, while the MXene@PANI-coated wool yarns demonstrated a higher charge transfer resistance (R_{CT}). For CPE₁, the MXene @PANI-coated wool yarns had a higher calculated value than the MXene @PPY-coated wool yarns and a behavior further from ideal, as evidenced by their respective a1 values. This pattern is consistent for CPE₂ and a₂ values. The resistor representing the resistance contributed by the diffuse layer is lower for MXene@PPY yarns than for MXene@PANI yarns. Table 3 shows the calculated values for each component of the ECM used for the parallel yarn EIS results. In Table 3, the unit μSs^{a} refers to Siemens seconds to the power of a, which is a unitless value.

TABLE 3
ECM component values for MXene@conductive-
polymer yarns based on parallel yarn tests.

| Component | MXene@PPY | MXene@PANI |
|---|---|---|
| R_{S} (ohm, Ω) | 292 | 258.5 |
| R_{CT} (ohm, Ω) | 891.1 | 1445 |
| CPE₁ (μSs^{a}) | 378.2 | 622.9 |
| a₁ | 0.538 | 0.487 |
| CPE₂ (μSs^{a}) | 99.62 | 79.8 |
| a₂ | 0.879 | 0.819 |
| R_{D} (ohm, Ω) | 116.9 | 344.7 |

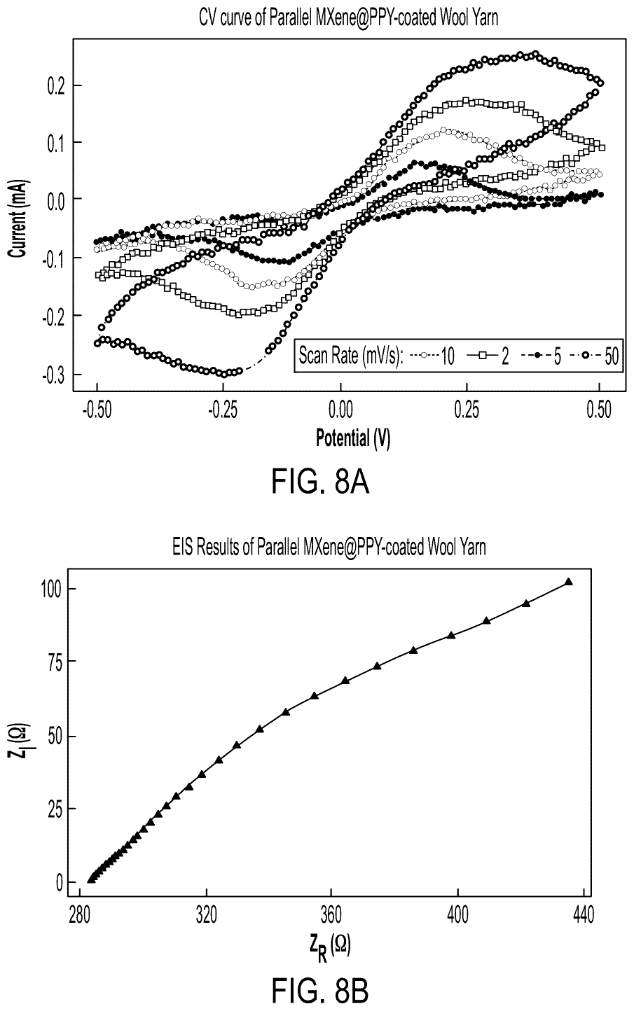

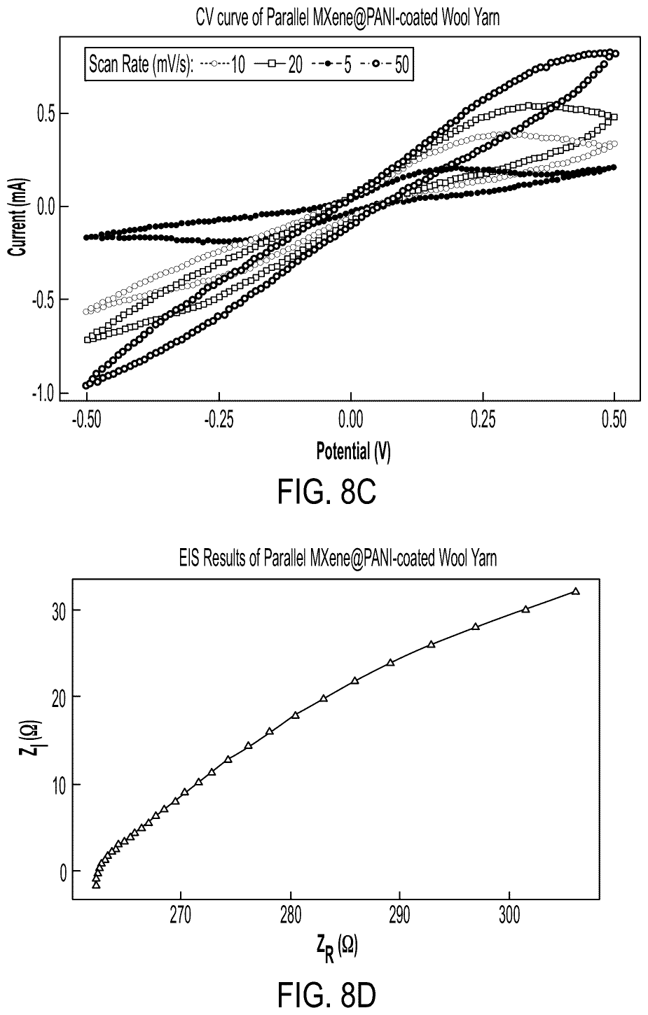

FIGS. 8A-8D illustrate the CV and EIS results of parallel yarn tests of MXene@PPY and MXene@PANI respectively coated onto wool yarn 10 times. For MXene@PPY-coated wool yarn represented in the CV data of FIG. 8A, redox peaks are observed on the anodic and cathodic curves at all scan rates, but the current range is narrower than the CV curves of the conductive yarn coated five times with the MXene@PPY composite material. The EIS curve of MXene@PPY-coated wool yarn represented in FIG. 8B demonstrates little change from the EIS results of the MXene@PPY-coated wool yarn of FIG. 7B. CV results for the MXene@PANI-coated wool yarn represented in FIG. 8C indicates an increased current range and similar charging behavior, with redox peaks becoming observable at lower scan rates. The EIS results for the MXene@PANI-coated wool yarn represented in FIG. 8D demonstrates a slightly rounder portion of the EIS curve at low frequencies, indicating a smoother surface than the MXene@PPY composite coating onto the wool yarn.

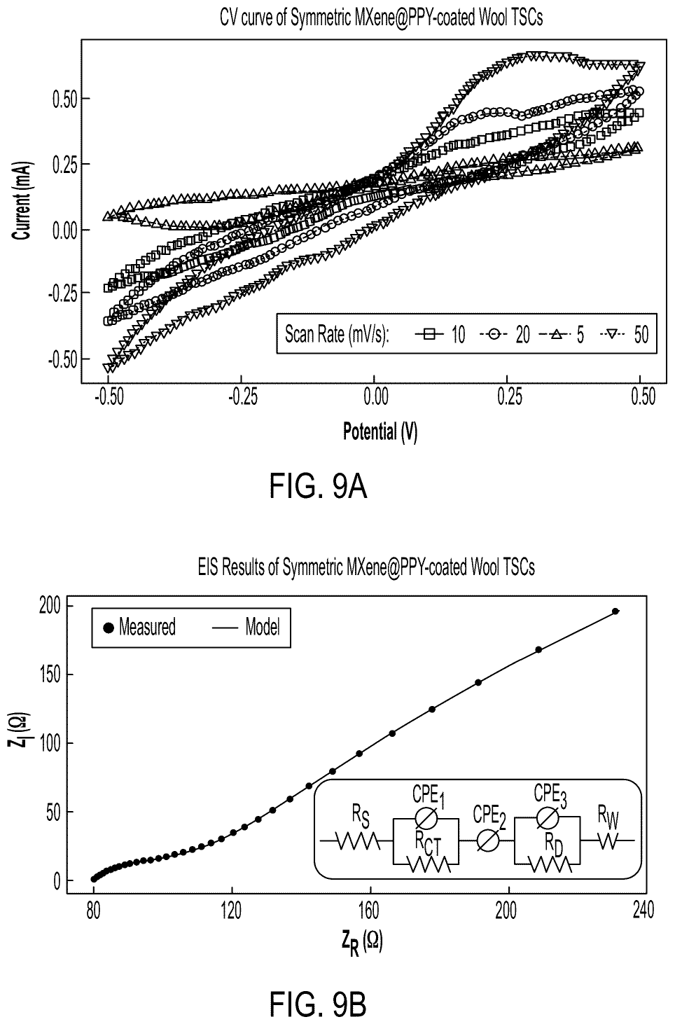

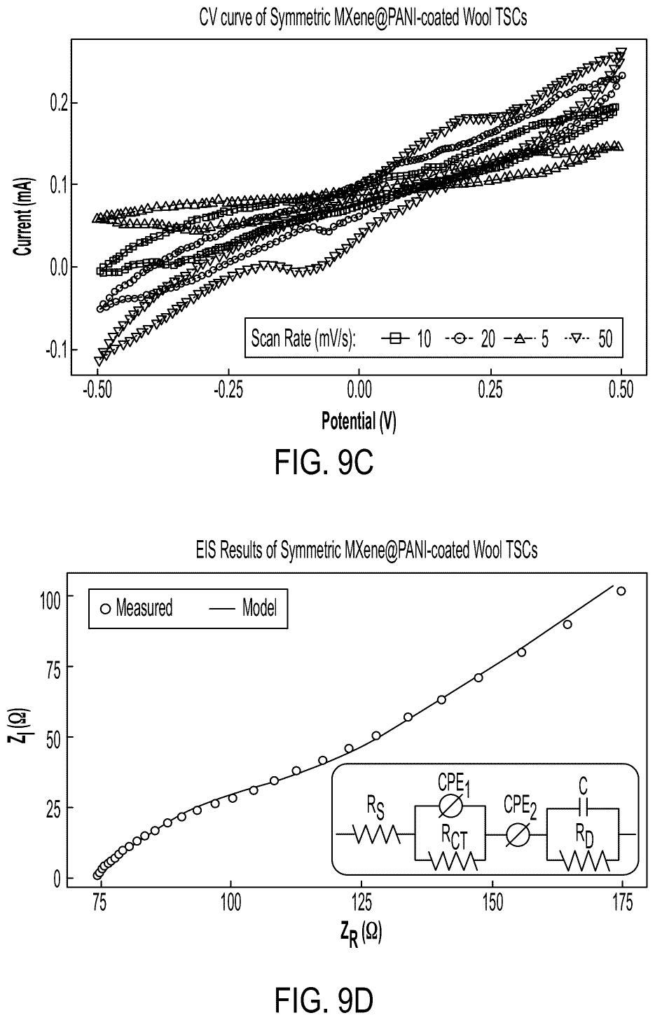

FIGS. 9A and 9B respectively illustrate CV and EIS curves for TSCs fabricated from conductive wool yarns coated five times with the MXene@PPY composite material. In FIG. 9A, redox peaks on the anodic portion of the CV curve were observable at all scan rates, and appeared in the cathodic portion of the curve at slower scan rates. In the EIS curve of FIG. 9B, the semicircular portion is flattened, indicating a rough 3-dimensional (3D), non-ideal surface. The linearly increasing portion indicates Warburg resistance. The ECM inset in FIG. 9B features a series resistor (R_{S}) representing the resistance contributed by the contact with the current collector and the electrode spacing. A CPE in parallel with a resistor (R_{CT}) represent the capacitance contributed by the Stem layer at the electrode surface, and the charge transfer resistance caused by the ion exchange during the redox reactions. A second CPE represents the capacitance contributed by the Helmholtz layer, followed by another CPE in parallel with a resistor (R_{D}) to represent the capacitance and resistance from the diffuse layer in between the electrodes. A final resistor (R_{W}) represents the Warburg resistance caused by the diffusion of ions across the electrode separator.

FIGS. 9C and 9D respectively illustrate CV and EIS curves for TSCs fabricated from conductive wool yarns coated five times with the MXene@PANI composite material. In FIG. 9C, redox peaks were observable on the anodic and cathodic portions of the CV curves at all scan rates. The EIS results of FIG. 9D feature a semicircular portion of the curve rounder than what is observed in the MXene@PPY EIS curve, indicating a relatively smoother surface. The ECM inset in FIG. 9D features a series resistor (R_{S}) representing the resistance contributed by the contact with the current collector and the electrode spacing. A constant phase element (CPE) in parallel with a resistor (R_{CT}) represent the capacitance contributed by the Stem layer at the electrode surface, and the charge transfer resistance caused by the ion exchange during the redox reactions. A second CPE represents the capacitance contributed by the Helmholtz layer, followed by a capacitor (C) in parallel with a resistor (R_{D}) to represent the capacitance and resistance from the diffuse layer in between the electrodes. Since the MXene@PANI TSCs can be partially modeled with a capacitor and its EIS curve features a rounder semicircular portion, it can be concluded that the MXene@PANI composite is smoother than the MXene@PPY composite.

The specific areal capacitance of symmetric wool TSCs coated five times with MXene@PANI was calculated to be 207.85 millifarad per square centimeter (mF/cm²), while the specific areal capacitance of symmetric wool TSCs coated five times with MXene@PPY was calculated to be 181.06 mF/cm², both determined at a scan rate of 5 mV/s. While the capacitance reported here is lower than pure MXene wool TSCs, the calculated values are still comparable to their pure MXene predecessors. Additionally, there was no observed degradation of performance over time as is routinely observed in pure MXene TSCs due to oxidation of the conductive coating. The positively charged conductive coating also had improved adhesion to the wool fiber surface, with little to no material rubbing off during handling of the yarn during hand knitting or testing. Table 4 indicates the calculated values for each individual ECM component.

TABLE 4
ECM component values for composite TSCs.

| Component | MXene@PPY | MXene@PANI |
|---|---|---|
| R_{S} (ohm, Ω) | 79.18 | 70.62 |
| R_{CT} (kiloohm, kΩ) | 1.030 | 1.387 |
| CPE₁ (μSs^{a}) | 89.9 | 61.3 |
| a₁ | 0.79 | 0.71 |
| CPE₂ (Ss^{a}) | 26.5 × 10⁻⁶ | 0.0014 |
| a₂ | 0.74 | 0.36 |
| R_{D} (ohm, Ω) | 26.92 | 17.65 |
| CPE₃ (Ss^{a}) | 0.00139 | NA |
| a₃ | 0.37 | NA |
| C (microfarad, μF) | NA | 2.359 |
| Rw (mSs^{1/2}) | 2 | NA |

MXene@PPY TSCs demonstrated higher series resistance (R_{S}) than their MXene@PANI counterparts, while MXene@PANI TSCs demonstrated higher charge transfer resistance (R_{CT}). This is corroborated by the calculated values for CPE₁, where MXene@PPY TSCs have a higher value than MXene@PANI TSCs, but the former has a behavior closer to ideal than the latter, as indicated by their respective a₁ values. The capacitance contribution from the Helmholtz layer is higher in the value for CPE₂ for MXene@PANI TSCs than for MXene@PPY TSCs, but the pattern of deviation from ideal behavior remains the same as evidenced by their a₂ values. CPE₃ for the MXene@PPY TSC ECM is much higher than the other calculated values for the same component type, but its behavior is much further from ideality as shown by a₃. The Warburg diffusion also has a low value calculated for that component of the ECM. The resistor representing the resistance contributed by the diffuse layer is higher for MXene@PPY TSCs than for MXene@PANI TSCs. For MXene@PANI TSCs, the capacitance contribution from the diffuse layer is also low, likely indicating that, for this composite coating, diffusion does not contribute much to its overall capacitance.

Generally, PPY and PANI oxidize to store charge, while the charge storage mechanism of Ti₃C₂Tₓ MXenes have been attributed to the oxide network in between the titanium layers of the MXene flakes. The —O and —OH surface terminations of the Ti₃C₂Tₓ MXene flakes act as a catalyst for the polymerization of the PPY and PANI conductive polymers. For PPY, the —O surface terminations in between the layers of the MXene flakes exchange electrons with pyrrole monomers, which then form dimers and polymerize a film of conductive polymer on the MXene surface and in between the layers of MXene flakes. For PANI, the —OH surface terminations exchange electrons with the aniline monomers to form dimers, which polymerize to create a conductive polymer film on the MXene flake surface and in between the layers of MXene flakes. MXene generally oxidizes into titanium oxide (TiO₂) when exposed to oxygen. However, it is presently recognized that, with the conductive polymer coating the MXene flakes, oxygen can no longer access the titanium layers. This prevents the formation of TiO₂ crystals and thus preserves the long-term performance of the TSCs fabricated using protein-based yarn coated with MXene@PPY or MXene@PANI.

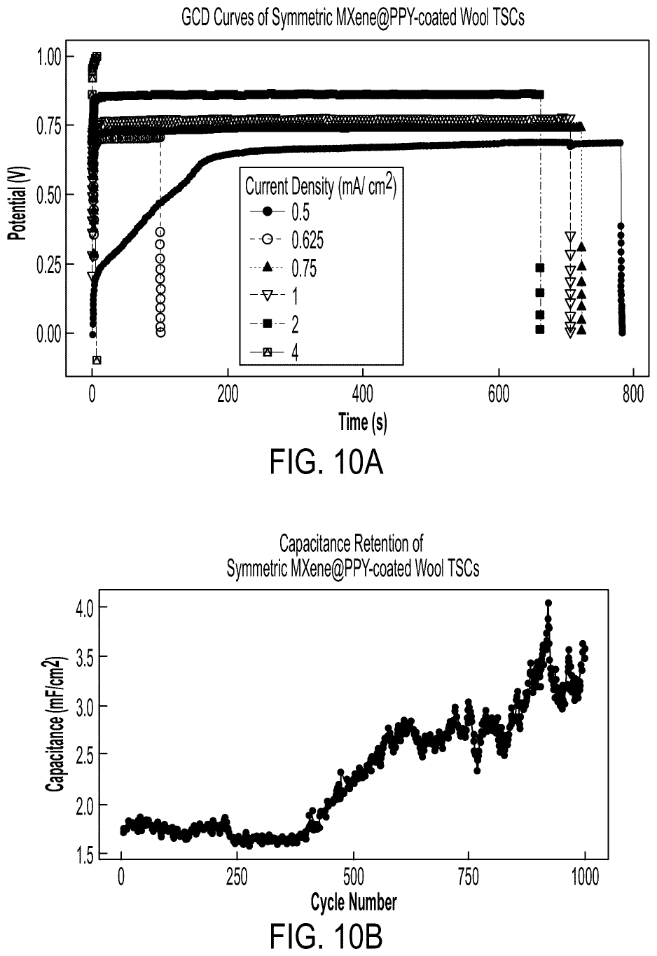

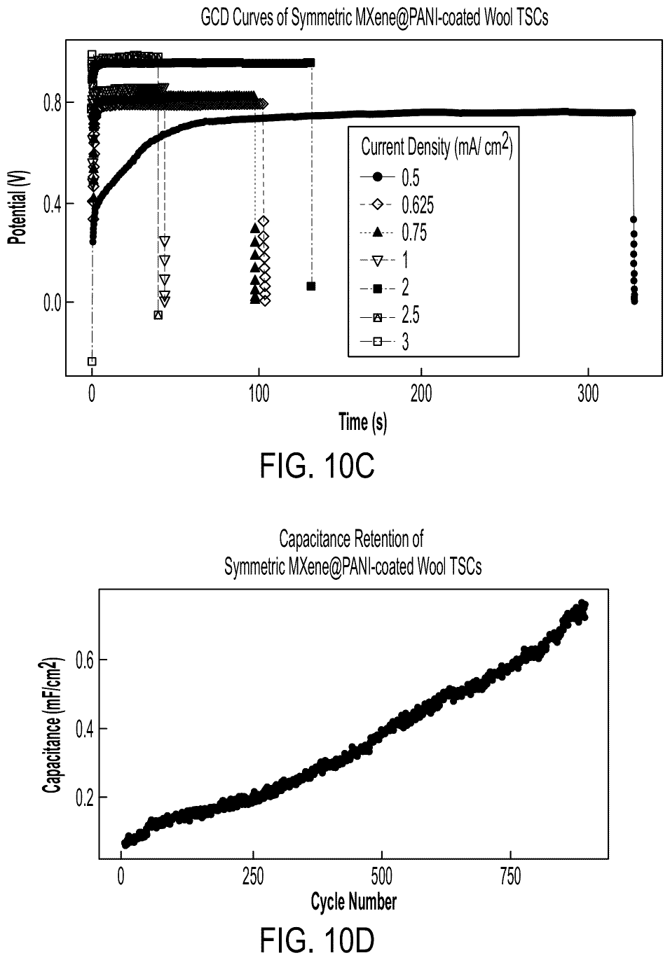

FIGS. 10A-10D illustrate the results of galvonostatic charge-discharge (GCD) curves and capacitance retention for MXene@PPY and MXene@PANI TSCs. The charge (FIG. 10A) and discharge (FIG. 10B) rate for MXene@PPY TSCs and the charge (FIG. 10C) and discharge (FIG. 10D) rate for MXene@PANI TSCs was proportional to the current density applied to the TSCs during GDC cycling. The capacitance retention for MXene@PPY TSCs had inconsistent behavior with varying increases and decreases in capacitance until about 850 cycles, when it started to decrease more consistently. The increase in capacitance is attributed to the wool fibers absorbing the electrolyte with time, resulting in improved cycling abilities due to the decreased distance ions must diffuse during charging and discharging. The inconsistent behavior is attributed to the degradation of PPY caused by repeated swelling and shrinking during cycling. A similar but steady increase was observed in the MXene@PANI TSCs in FIG. 10D, which was attributed to the wool fiber absorption abilities, as previously discussed.

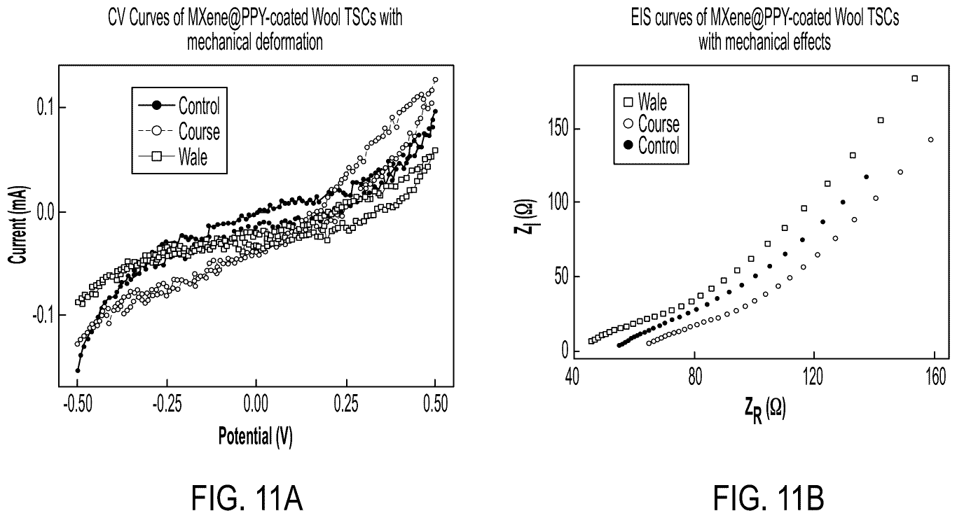

MXene@PPY TSCs were also stretched during CV and EIS electrochemical testing to evaluate the effects of mechanical deformation. As illustrated by the CV curves of FIG. 11A collected at a scan rate of 50 millivolts per second (mV/s), course-wise and wale-wise stretching along the width of MXene@PPY TSCs drastically increased their resistive behavior observed in their CV curves, resulting in narrower curves and a narrower current range. This is attributed to the stainless-steel clips used during deformation tests, increased electrode size due to deformation, and, in the case of course-wise stretching, to the increased electrode spacing. During course-wise stretching, individual knit loops are more open, and the yarn and fibers have fewer contact points with itself or with each other, decreasing the number of pathways available to electrons during charging or discharging, while simultaneously the contact points between loops of the yarn tighten, improving the connections that remain. The EIS results presented in FIG. 11B for MXene@PPY TSCs during deformation feature decreased series resistance attributed to the stronger contact with the stainless-steel clips acting as current collectors. MXene@PPY TSCs with wale-wise stretching had the lowest series resistance, attributed to the decreased electrode spacing caused by this mechanical deformation. The CV curves still show higher resistive behavior caused by the stainless-steel clips used for electrochemical testing to characterize the effect of mechanical deformation on composite TSC performance. In the CV curves of MXene@PPY TSCs, small oxidation peaks can still be observed on the anodic portion of the curve since this material preferentially oxidizes to store charge, and in its un-stretched state anodic redox peaks could be observed at all scan rates of its CV curves. Composite TSCs cycled under mechanical deformation had stable behavior up to 1000 cycles. While not wishing to be bound by theory, it is believed that an increase in capacitance retention was not observed for composite TSCs under strain (as was observed for the unstrained composite TSCs) due to the applied tension squeezing the fibers, which prevents the fibers from absorbing more electrolyte.

Other objects, features, and advantages of the disclosure will become apparent from the foregoing figures, detailed description, and examples. It should be understood, however, that the figures, detailed description, and examples, while indicating specific embodiments of the disclosure, are given by way of illustration only and are not meant to be limiting. Additionally, it is contemplated that changes and modifications within the spirit and scope of the disclosure will become apparent to those skilled in the art from the detailed description. In further embodiments, features from specific embodiments may be combined with features from other embodiments. For example, features from one embodiment may be combined with features from any of the other embodiments. In further embodiments, additional features may be added to the specific embodiments described herein.

What is claimed is:

1. A conductive protein-based yarn, comprising:
a plurality of keratin fibers coated with a composite material, the composite material comprising conductive-polymer-coated MXene flakes (MXene@conductive-polymer).

2. The conductive protein-based yarn of claim 1, wherein the MXene@conductive-polymer composite material comprises polypyrrole (PPY)-coated MXene flakes (MXene@PPY).

3. The conductive protein-based yarn of claim 1, wherein the MXene@conductive-polymer composite material comprises polyaniline (PANI)-coated MXene flakes (MXene@PANI).

4. The conductive protein-based yarn of claim 1, wherein the conductive protein-based yarn has a specific linear capacitance greater than 0.15 millifarad per centimeter (mF/cm).

5. The conductive protein-based yarn of claim 1, wherein the MXene flakes comprise Ti₃C₂Tₓ MXene flakes.

6. The conductive protein-based yarn of claim 1, wherein the conductive protein-based yarn comprises from about 10 weight percent (wt. %) to about 25 wt. % of the MXene@conductive-polymer composite material.

7. The conductive protein-based yarn of claim 1, wherein the protein-based yarn is a sheep wool yarn, cashmere, or angora.

8. The conductive protein-based yarn of claim 1, wherein the plurality of keratin fibers has been coated with the composite material between five and ten times.

9. The conductive protein-based yarn of claim 1, wherein the plurality of keratin fibers coated with the composite material have a higher tensile stress at tensile strength and a higher load at tensile strength compared to the plurality of the keratin fibers prior to coating with the composite material.

10. A textile supercapacitor (TSC), comprising:
electrodes knitted from a conductive protein-based yarn, the conductive protein-based yarn being coated in a composite material, the composite material comprising conductive-polymer-coated MXene flakes (MXene@conductive-polymer);
an electrode separator disposed between the electrodes and knitted from a non-conductive yarn; and
an electrolyte absorbed into the conductive protein-based yarn of the electrodes and the non-conductive yarn of the electrode separator.

11. The TSC of claim 10, wherein the MXene@conductive-polymer composite material comprises polypyrrole (PPY)-coated MXene flakes (MXene@PPY), and wherein the TSC has a specific areal capacitance greater than 180 millifarad per square centimeter (mF/cm²) at a scan rate of 5 millivolts per second (mV/s).

12. The TSC of claim 10, wherein the MXene@conductive-polymer composite material comprises polyaniline (PANI)-coated MXene flakes (MXene@PANI), and wherein the TSC has a specific areal capacitance greater than 200 mF/cm² at a scan rate of 5 mV/s.

13. The TSC of claim 10, wherein the conductive protein-based yarn comprises from about 10 weight percent (wt. %) to about 25 wt. % of the MXene@conductive-polymer composite material, and wherein the TSC comprises hand-knitted stiches in an intarsia pattern, machine-knitted jersey stiches, or a combination thereof.

14. A method, comprising:
combining MAX phase material with water, hydrochloric acid (HCl), and hydrofluoric acid (HF) at elevated temperature to yield MXene flakes;
polymerizing a monomer of conductive polymer in the presence of the MXene flakes to yield a composite material, the composite material comprising conductive-polymer-coated MXene flakes (MXene@conductive-polymer); and
coating a protein-based yarn with the MXene@conductive-polymer composite material, thereby to yield a conductive protein-based yarn.

15. The method of claim 14, comprising:
knitting a textile supercapacitor (TSC) using the conductive protein-based yarn, wherein at least one electrode of the TSC is knitted from the conductive protein-based yarn.

16. The method of claim 15, comprising submerging the TSC in an electrolyte solution that contains phosphoric acid.

17. The method of claim 14, wherein coating the protein-based yarn with the MXene@conductive-polymer composite material further comprises submerging the protein-based yarn in a colloidal solution of the MXene@conductive-polymer composite material and then drying the protein-based yarn, thereby to yield the conductive protein-based yarn.

18. The method of claim 17, wherein coating the protein-based yarn with the MXene@conductive-polymer composite material comprises:
loading a reservoir of an autocoater with the colloidal solution;
loading a spool of the protein-based yarn into the autocoater; and
activating the autocoater to automatically submerge the protein-based yarn in the colloidal solution and then to at least partially dry the protein-based yarn across a series of rollers.

19. The method of claim 14, wherein the MAX phase material comprises Ti₃AlC₂Tₓ MAX powder and the MXene flakes comprise Ti₃C₂Tₓ MXene flakes.

20. The method of claim 14, wherein (i) the monomer is pyrrole and the MXene@conductive-polymer composite material comprises polypyrrole (PPY)-coated MXene flakes (MXene@PPY) or (ii) the monomer is aniline and the MXene@conductive-polymer composite material comprises polyaniline (PANI)-coated MXene flakes (MXene@PANI), and wherein the conductive protein-based yarn comprises from about 10 weight percent (wt. %) to about 25 wt. % of the MXene@conductive-polymer composite material.
